(19) United States
(12) Patent Application Publication
(10) Pub. No.: US 2013/0308475 A1
(43) Pub. Date: Nov. 21, 2013

(54) METHOD AND SYSTEM FOR CONTROLLING UPLINK INTERFERENCE IN HETEROGENEOUS NETWORKS

(71) Applicant: QUALCOMM INCORPORATED, San Diego, CA (US)

(72) Inventors: Samel CELEBI, Summit, NJ (US); Adam C. POLAK, Amherst, MA (US); Luca BLESSENT, Bridgewater, NJ (US)

(73) Assignee: QUALCOMM INCORPORATED, San Diego, CA (US)

(21) Appl. No.: 13/801,377

(22) Filed: Mar. 13, 2013

Related U.S. Application Data
(60) Provisional application No. 61/649,628, filed on May 21, 2012.

(51) Int. Cl. H04W 24/02

(52) U.S. Cl. CPC H04W 24/02
USPC 370/252

(57) ABSTRACT

The present disclosure presents a method and apparatus for controlling an uplink (UL) rate of one or more use equipments (UEs) served by a base station. For example, the method may include obtaining one or more measurements of a plurality of signals from a sub-set of the one or more UEs served by the base station over a period of time. Furthermore, such an example method may include comparing the measurements to one or more respective target values to generate a power activity indicator (PAI) metric and comparing the measurements to one or more respective target values to generate a power activity indicator (PAI) metric. As such, the uplink interference in heterogeneous networks may be controlled.

### CLAIM OF PRIORITY UNDER 35 U.S.C. §119

The present Application for Patent claims priority to U.S. Provisional Patent Application No. 61/649,628 filed May 21, 2012, entitled “Method and System for Controlling Uplink Interference in Heterogeneous Networks,” which is assigned to the assignee hereof, and hereby expressly incorporated by reference herein.

### BACKGROUND

1. Field

Aspects of the present disclosure relate generally to wireless communications, and more particularly to controlling interference in wireless networks.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth.

To supplement conventional base stations, low power base stations, for example, femto cells, pico cells, etc. can be deployed to provide more robust wireless coverage to mobile devices. As deployment of such base stations is unplanned, such low power base stations can interfere with communications of other base stations and/or UEs when base stations are deployed within a close vicinity of one another. Such interference can result in poor network performance and/or stability, for example, low up link (UL) rate for user equipment (UE).

For example, uplink interference and/or network performance are typically managed by controlling the UL rates of UEs. The existing approaches monitor the rise over thermal (ROT) parameters to make decisions about the UL rate control at the UE. ROT is the ratio of the received signal power to the thermal noise, and generally a reliable indicator of overall interference level and the system stability for macro networks that have geometric regularity and support handoffs. However, uplink interference control algorithms generally tailored for macro cells may yield less than desired network performance when small cells, for example, femtocells, pico cells, etc. are introduced into the network along macro cells as some of the geometric regularity and handoff assumptions are no longer valid.

### SUMMARY

The following presents a simplified summary of one or more aspects in order to provide a basis understanding of such aspects. This summary is not an extensive overview of all contemplated aspects, and is intended to neither identify key or critical elements of all aspects not delineate the scope of any or all aspects. Its sole purpose is to present some concepts of one or more aspects in a simplified form as a prelude to the more detailed description that is presented later.

The present disclosure presents example method and apparatus for wireless communication. For example, the present disclosure presents an example method for controlling an uplink (UL) rate of one or more user equipments (UEs) served by a base station that comprises obtaining one or more measurements of a plurality of signals from a sub-set of the one or more UEs served by the base station over a period of time. In addition, such method may include comparing the measurements to one or more respective target values to generate a power activity indicator (PAI) metric, and determining whether to manage the UL rate of the one or more UEs based at least on the PAI metric.

In an additional aspect, the present disclosure presents an example apparatus for controlling an uplink (UL) rate of one or more user equipments (UEs) served by a base station that comprises means for obtaining one or more measurements of a plurality of signals from a sub-set of the one or more UEs served by the base station over a period of time. In addition, such apparatus may include means for comparing the measurements to one or more respective target values to generate a power activity indicator (PAI) metric, and means for determining whether to manage the UL rate of the one or more UEs based at least on the PAI metric.

Moreover, the present disclosure presents an example computer program product for controlling an uplink (UL) rate of one or more user equipments (UEs) served by a base station, comprising a computer-readable medium comprising code for obtaining one or more measurements of a plurality of signals from a sub-set of the one or more UEs served by the base station over a period of time. In addition, such computer program products may further include code for comparing the measurements to one or more respective target values to generate a power activity indicator (PAI) metric, and determining whether to manage the UL rate of the one or more UEs based at least on the PAI metric.

In a further aspect, the present disclosure presents an apparatus for controlling an uplink (UL) rate of one or more user equipments (UEs) served by a base station, that includes a signal measuring component to obtain one or more measurements of a plurality of signals from a sub-set of the one or more UEs served by the base station over a period of time. In addition, the apparatus may be further configured to include a signal comparing component to compare the measurements to one or more respective target values to generate a power activity indicator (PAI) metric, and a UL rate determining component to determine whether to manage the UL rate of the one or more UEs based at least on the PAI metric.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram of an example wireless communication system of aspects of the present disclosure;

FIG. 2 is a block diagram of an example base station in aspects of the present disclosure;

FIG. 3 is a flow diagram illustrating aspects of a method for controlling uplink interference in heterogeneous networks;

FIG. 4 is an example flow diagram illustrating an aspect of an example methodology for determining whether to adjust UL rates based on a number of power-up commands;

FIG. 5 is a component diagram illustrating aspects of a logical grouping of electrical components as contemplated by the present disclosure;

FIG. 6 is a schematic block diagram of an aspect of a wireless network environment that can be employed in conjunction with the various systems and methods described herein;

FIG. 7 is a schematic block diagram of an aspect of a wireless network environment that can be employed in conjunction with the various systems and methods described herein;

FIG. 8 illustrates an example wireless communication system, configured to support a number of devices, in which the aspects herein can be implemented;

FIG. 9 is block diagram illustrating an example of a hardware implementation for an apparatus employing a processing system; and

FIG. 10 is a block diagram illustrating aspects of a computer device according to the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure provides a method and apparatus for controlling uplink interference in heterogeneous networks by obtaining one or more measurements of a plurality of signals from a sub-set of the one or more UEs served by the base station over a period of time, comparing the measurements to one or more respective target values to generate a power activity indicator (PAI) metric, and determining whether to manage the UL rate of the one or more UEs based at least on the PAI metric. For example, in an aspect, a base station can measure signals received from a UE to obtain measurements, for example, SNR, SINR, etc., over a period of time, compare these measurements to their respective target values to determine a novel metric, for example, a power activity indicator (PAI), and determine whether the UL rate of the UEs have to be managed when the PAI metric is above a threshold.

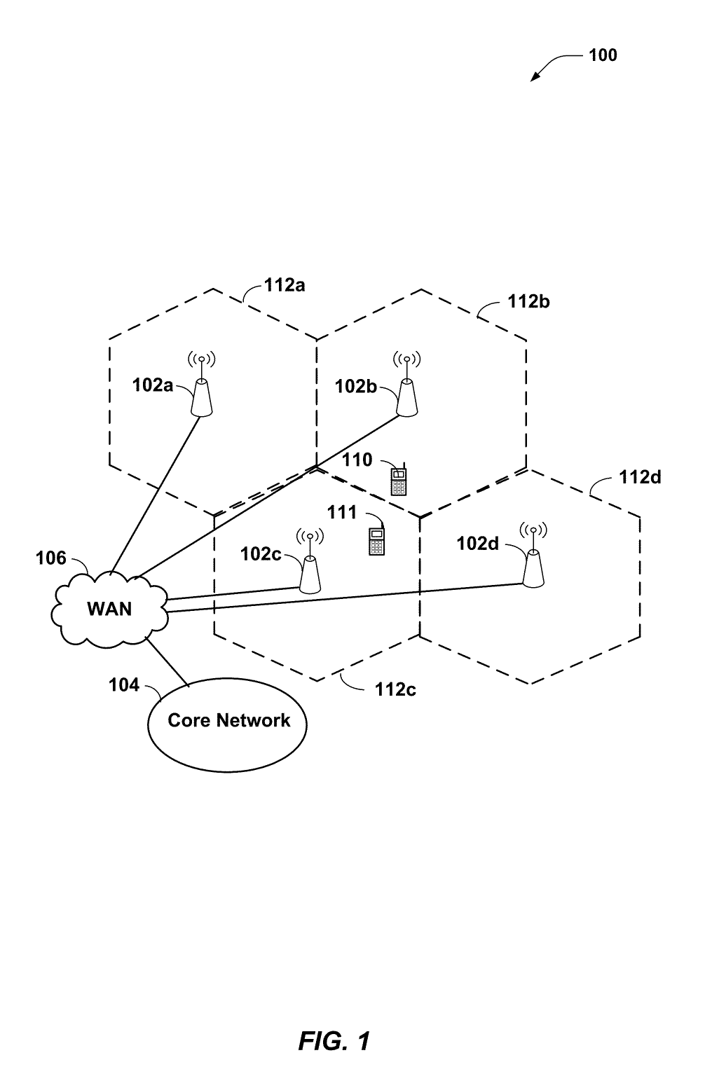

Referring to FIG. 1, a wireless communication system 100 is illustrated that facilitates controlling uplink interference in heterogeneous networks. System 100 includes a plurality of base stations, for example, 102a-d. Base stations 102a-d can be macro cells, femtocells, macro cells, pico cells, or any high-power or low-power base stations, in communication with an operator's core network 104 via a wide area network (WAN) 106.

In an example aspect, 102a-d may be low power femtocells and may not be equipped with a conventional transmission/antenna tower. A femtocell may be installed and activated arbitrarily without any planning. For example, a network operator may provide femtocells to various third parties, for example, consumers that purchase and deploy femtocells in their homes, offices, etc. While a network operator may install and operate some femtocells in system 100, for example, at corporate locations, each femtocell 102a-d may be autonomously controlled as described herein, and can be added and removed from the system 100 at any time.

Coverage areas of base stations 102a-d can be identified by 112a-d respectively. For example, coverage area 112a may be provided by base station 102a. However, it should be appreciated that coverage areas 112a-d may not have a regular or uniform geometrical shape for low-power base stations, for example, femtocells, and may vary in shape and coverage based on factors such as landscape topology, presence or absence of blocking objects at the location, etc. The disclosure is explained in the context of a base station which includes any type of cell, including, for example, a macro cell, a femto cell, a pico cell, etc. Base stations 102a-d can provide service to UEs, for example, base station 102b to UE 110 and base station 102c to UE 111 depending on the location of the UE.

In an example aspect, base station 102b can serve UE 110 which is located within coverage area 112b of base station 102b. The communications between UE 110 and base station 102b, for example, on the uplink (UL) from the UE to the base station, may interfere with communications of other neighboring base stations and/or UEs, for example, base station 102c and/or UE 111, and/or communications between base station 102c and UE 111.

To mitigate such interference, for example, base station 102b can measure signal properties of UE 110 and/or other UEs served by base station 102b, compare the measured signals with one or more target values to generate a novel indicator, for example, a power activity indicator (PAI), compare it with a threshold value to determine whether to control UL rate of the UEs, for example, UE 110.

In an example aspect, a signal-to-noise ratio (SNR) or other measurement of a number of signals from a UE, for example, UE 110 served by base station 102b can be obtained by base station 102b and compared to an acceptable or target SNR value. In an aspect, the target SNR value may configured at the base station. The number of signals received from one or more UEs that are below the target SNR value over a given time period are measured and a power activity indicator (PAI) metric is generated. If the PAI metric is over a threshold, it may indicate that UE 110 is increasing its UL transmit power to compensate for interference from other UEs or other femtocells as described above. In an aspect, the threshold(s) may be configured at the base station, and they may be configured at a base station level or a network level.

In an example aspect, the number of power up commands to the UEs (i.e., command to a UE to increase UL or transmit power of the UE) can be used to generate the PAI metric and compared with a threshold. If the generated PAI metric exceeds the threshold, base station 102b can command or otherwise request that UE 110 and/or other UEs served by base station 102b decrease their UL rate. This can be performed by a global indicator to all UEs served by base station 102b to lower their UL rate, or an explicit command to UE 110 to lower its UL rate, or a resource assignment to UE 110 from base station 102b to decrease the UL rate of UE 110.

It is to be understood that UL rate and UE transmit power can be used interchangeably in this disclosure. Moreover, lowering the UL rate of a UE may correspond to lowering the allowed UL transmit power (for example, by issuing power control commands from base station 102 to UE 110) of a UE. In other examples described herein, base station 102b can consider additional parameters in determining whether to request or command UL rate adjustment of one or more UEs.

Base station 102b can utilize the functionality described above and can mitigate interference caused by UE 111 or other UEs served by base station 102b or other neighboring base stations. Although the functionality is described with respect to base station 102b, it is to be appreciated that functionality described above and further herein can be applied to or utilized by substantially any nodes that provide wireless network access, such as macro cells, femto cells, pico cells, relay nodes, peer-to-peer UEs, etc.

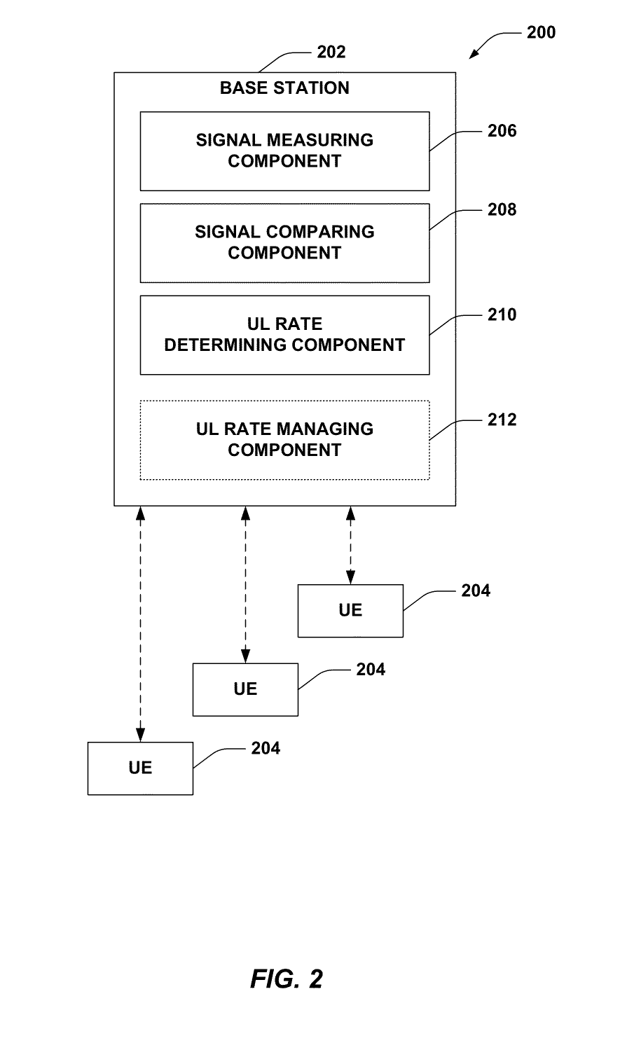

Referring to FIG. 2, an example wireless communication system 200 is illustrated that facilitates controlling UL rate of one or more UEs served by a base station 202 based on obtaining one or more measurements of a plurality of signals from a sub-set of the one or more UEs served by the base station over a period of time, comparing the measurements to one or more respective target values to generate a power activity indicator (PAI) metric, and determining whether to manage the UL rate of the one or more UEs based at least on the PAI metric.

In an aspect, system 200 includes a base station, for example, base station 102b, that provides network access to one or more UEs, such as UE(s) 204. In an example aspect, base station 202 can be substantially any type of base station, for example, macro cell, femtocell, pico cell, a portion thereof, etc., as described, a mobile base station, a relay, a UE (for example, communicating in peer-to-peer or ad-hoc mode with other UEs), etc. UEs 204 can each be a mobile terminal, stationary device, modem (or other tethered devices), a portion thereof, and/or substantially any device that wirelessly communicates with femto and/or macro nodes, including base station 102a-d and/or 202.

In an aspect, signal measuring component 206 can be configured to obtain one or more measurements of a plurality of signals from a sub-set of the one or more UEs served by the base station over a period of time. For example, base station 202 can obtain a plurality of signals from UEs 204 served by the base station 202, and measure such signals over a period of time. The measurements performed by the base station may include measuring signal quality or strength metrics related to signals from the UEs, for example, signal-to-noise ratio (SNR), signal-to-interference-and-noise ratio (SINR), received power, bit or frame error rate, and/or the like. It is to be appreciated that SNR and SINR can be used interchangeably herein, and that the functionalities described can apply to SNR, SINR, or other signal quality or strength measurement metrics.

In an aspect, signal comparing component 208 can be configured to compare the measurements to one or more respective target value to generate a power activity indicator (PAI) metric. For example, SNR of signals received from the UE(s) 204, and/or one or more other served UEs, to a target SNR over a period of time. In an additional aspect, signal comparing component 208 can measure other metrics, for example, frequency of occurrence where the SNR of UE(s) 204 is below a target SNR value in a given time period and generate a metric, for example, a power activity indicator (PAI) metric.

In an aspect, UL rate determining component 210 can be configured to determine whether to manage the UL rate of the one or more UEs based at least on the PAI metric. For example, the PAI metric is used to determine whether the UL rate of the UEs should be managed, for example, decreased or increased, based on whether the PAI metric is above a threshold. In an example aspect, if the PAI metric is above the threshold, the UL rate can be decreased and if the PAI metric is below the threshold, the UL rate can be increased.

In an aspect, UL rate managing component can 212 can be configured to manage the UL rate of the one or more UEs by sending a message to a sub-set of the plurality of the UEs to adjust the UL rate in response to the determining. For example, if the UL rate determining component 210 determines that the UL rate has to be managed, UL rate adjusting component 212 can send a message to one or more UEs to decrease the UL rate. In an aspect, this can be achieved by UL rate managing component by sending a message, for example, a request, a command, or an explicit indication to UE(s) 204 to modify rate, a resource allocation to the UE(s) 204 with a modified rate, one or more power control commands to adjust transmit power sent to the UE(s) 204, and/or the like. For instance, UL rate managing component 212 can utilize a scheduler of base station 202 to schedule resources to UE(s) 204 based on determining a UL rate management. In another example, signal comparing component 208 can compare SNR of signals received from all served UEs to the target SNR over the period of time, and UL rate determining component 210 can determine whether to adjust UL rate for all served UEs based on the comparison.

In an example, signal comparing component 208 can sum the differences between the target SNR value and the SNR of received signals for a plurality of UEs served by base station 202 over a period of time. If the summed difference is over a target value, UL rate determining component 210 can command, request, or otherwise cause the plurality of UEs to decrease rate. In one example, signal comparing component 208 can apply weights to measurements of a portion of the plurality of UEs; for example, higher weights can be applied to emphasize measurements of UEs with relatively higher transmit powers compared to other UEs served by base station 202. In an aspect, an advantage of such a closed loop power control mechanism (for example, where a base station controls the transmit power of UEs) as described above is that it can run locally on all or only select femtocells or macro cells without a need for coordination between the individual cells.

In an example, the closed loop power control mechanism described above can be based on a power activity indicator (PAI) metric, M, described below to control the UL rates of at least a portion of the UE(s) 204. Signal measuring component 206 measures the signals received by base station 202 and the signal comparing component 208 compares the signal measurements to a target value (for example, acceptable SNR value) and computes the value of M by calculating the frequency of signal measurements going above/below the target values. Depending on the value of M going above or below threshold T, the UL rate determining component 210 decides on UL rate decreases/increases for all or a specific subset, S, of UEs served by base station 202. UL rate managing component 212 can manage the rate control by a scheduling algorithm that schedules resources for utilization by one or more UE(s) 204, by broadcasting global rate control messages to the UE(s) 204, and/or the like. In one example, the power offset of UE k at time n can be defined as:

P_{Δ}(n, k) [symbol] f(SINR_{TGTdB}(n, k)−SINR_{RXdB}(n, k))

where SINR_{RXdB}(n, k) corresponds to the SINR of the signal received from the UE k, which can be one of UE(s) 204, at time n, and SINR_{TGTdB}(n, k) is the minimum SINR for UE k to achieve a desired UL rate, both of which can be expressed in decibels (dB). In addition, it is to be appreciated that SINR_{TGTdB}(n, k) may change for UE k over time.

The cost function f(x), above, can take on the following forms, for example:

$$f ( x ) = \{ \begin{matrix}{10}^{( x / 10 )} & if x > 0 \\ 0 & otherwise\end{matrix} \\ or \\ f ( x ) = \{ \begin{matrix}{x}^{r} & if x > 0 \\ 0 & otherwise\end{matrix} where r \geq 0$$

Moreover, in this example, the power moment sequence c(n) can be defined as the weighted sum of power offsets inflected by functional g(x):

c(n) [symbol] g{Σ_{k∈S}b_{n,k}P_{Δ}(n, k)}

For instance, the summation can be taken over a set of UEs of interest, S, that are served by base station 202. The coefficients b_{n,k} can be used to emphasize contributions from select UEs, as described. For example, b_{n,k} can be uniform across all the UE(s) 204 or can assume higher values for certain UEs, such as those with higher transmit powers. If the complex sinusoidal form bₙₖ=e^{i2πnk/N} is assumed, the coefficients b_{n,k} can also be used to emphasize low frequency patterns in the UL transmit power activity.

In an example, function g(x) can be of the following form:

g(x)=x^{q} q>0

In this example, setting q larger than one can emphasize concurrent power activity amongst UE(s) 204. Power activity metric M at time index n can be obtained by applying the operator d_{L}{ } to the power moment sequence c(n):

M(n)=d_{L}{c(n)} L=0, 1, 2, . . .

The operator can take one of multiple forms, such as the geometric sum: or the linear sum:

$${d}_{L} \{ c ( n ) \} = {\prod }_{m = n}^{n - L} c ( m )$$

$${d}_{L} \{ c ( n ) \} = {\sum }_{m = n}^{n - L} c ( m )$$

The former can be used to emphasize consecutive power activity along a time axis. The parameter L can relate to the observation window length. Thus, signal comparing component 208, in this specific example, computes M using the forgoing formulas. Subsequently, UL rate determining component 210 compares M to threshold T. If M≧T then UL rate managing component 212 can command, request, or otherwise cause UEs in set S to lower UL transmit power or rates. Otherwise, UL rate managing component 212 can command, request, or otherwise cause UEs to increase transmit powers or rates, continue using current transmit powers or rates, etc.

In an example, when applied to the EV-DO UL rate control with the following parameter set:

r=0 b_{n,k}×1 q=1 d_{L}{c(n)}=Σₘ₌ₙ^{n-L}c(m) L=12

the PAI metric, M, reduces down to counting the number of closed loop power control (CLPC) power-up commands issued by the base station 202 to at least some of its served UE(s) 204 within the last CDMA frame. In this example, signal measuring component 206 can count the commands, signal comparing component 208 can compare the signals to target value, UL rate determining component 210 can determine whether the number of commands, M, exceeds threshold T. Where UL rate adjusting component 210 determines that this number, M, exceeds the threshold T, UL rate managing component 212 can set a reverse activity bit (RAB) of base station 202 to request its UE(s) 204, or at least a portion thereof in set S, to throttle down their UL transmit power or rates. In one example, signal comparing component 208 can form different groups of UEs based on a set of parameters (for example, based on a current UL rate, location of the UEs, etc.), and UL rate managing component 212 can adjust UL rate of certain groups (for example, UL rate managing component 212 can increase UL rate for the group that has the lowest current UL rate or is further away from the base station 202).

Furthermore, for example, base station 202 can combine this power adjusting mechanism with other power control functionality. In one specific example, base station 202 can use RoT-based power control where UL rate managing component 212 commands, requests, or otherwise causes UE(s) 204, or at least a portion thereof in set S, to adjust transmit power based on an observed RoT at base station 202. Based on one or more events (for example, RoT increasing over a certain threshold, a SNR of at least one UE under the target SNR or at least under a threshold difference from the target SNR, etc.), base station 202 can switch to use the above power control functionality. It is to be appreciated that base station 202 can also switch back to RoT or other functionality based on alternate events (for example, RoT decreasing under a threshold, SNR below the target or at least a threshold difference from the target, etc.).

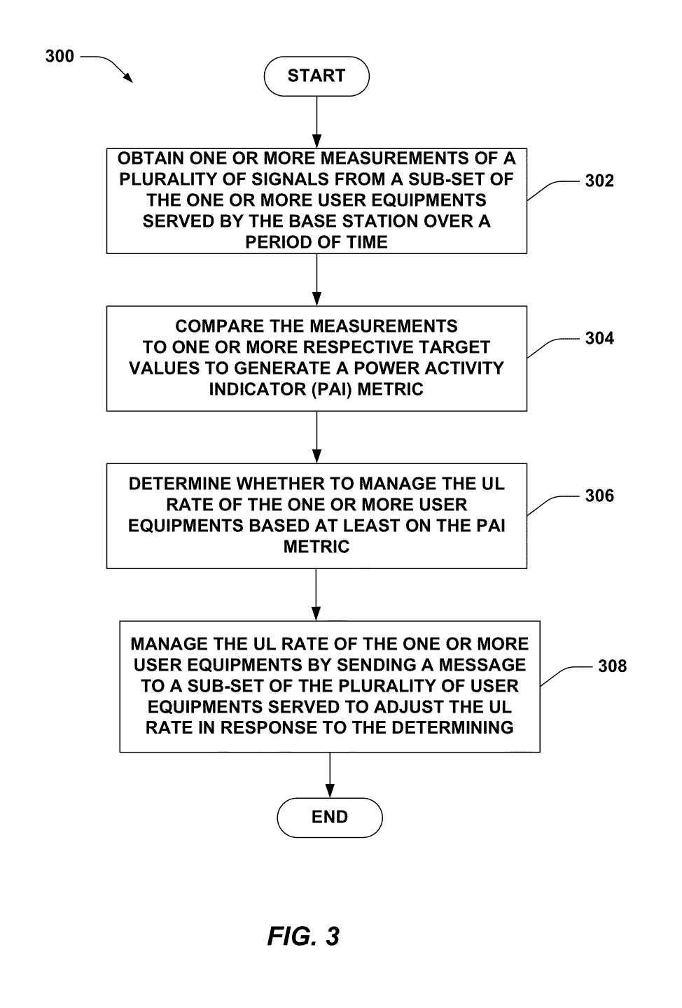

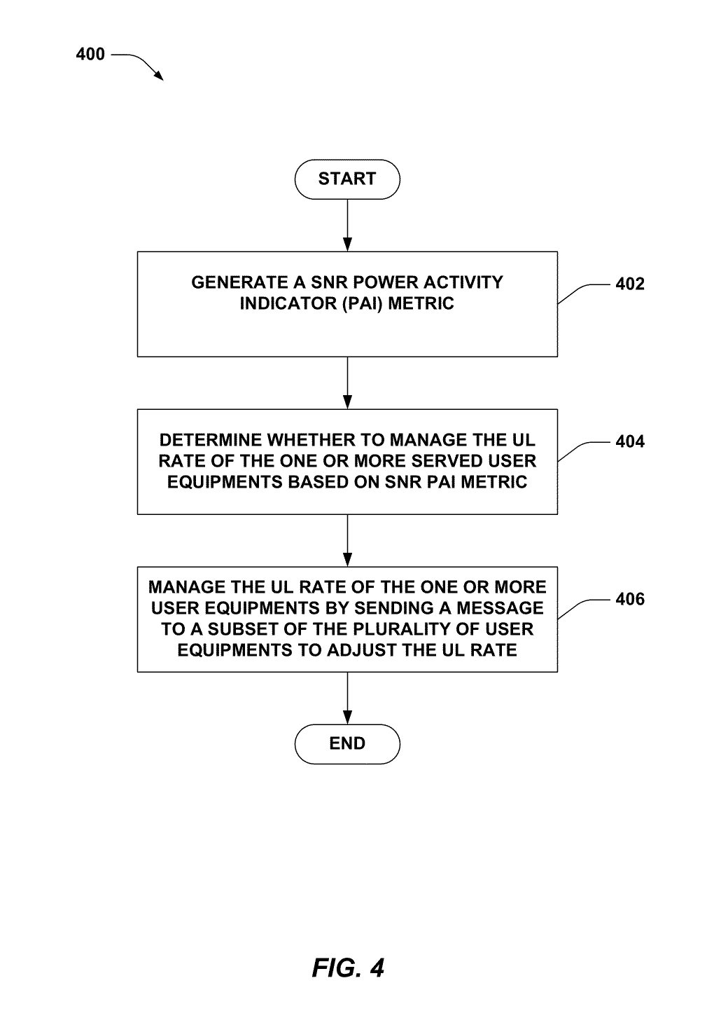

FIGS. 3-4 illustrate example methodologies relating to managing UL rate of one or more served UEs. While, for purposes of simplicity of explanation, the methodologies are shown and described as a series of acts, it is to be understood and appreciated that the methodologies are not limited by the order of acts, as some acts may, in accordance with one or more embodiments, occur concurrently with other acts and/or in different orders from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

FIG. 3 illustrates an example methodology 300 for controlling an UL rate of one or more UEs served by a base station. In an aspect, at block 302, methodology 300 may include obtaining a plurality of measurements of signals received from each of a plurality of served UEs over a period of time can be obtained. For example, in an aspect, base station 202 and/or signal measuring component 206 may obtain one or more measurements of signals received from UEs served by the base station over a period of time. The measurements by the base station can be for example, SNR, SINR, etc.

Furthermore, at block 304, methodology 300 may include comparing the measurements to one or more respective target values to generate a power activity indicator (PAI) metric. For example, in an aspect, the measurements of each of the plurality of served UEs can be compared to one or more target measurements to generate a PAI metric. As described above, this can include comparing the SNRs of the signals received from the UEs to one or more target SNRs, comparing the number of signals with SNR under the target SNR value (or a corresponding number of power-up commands) to a threshold. For example, the PAI metric can correlate to M described above, and the threshold to T.

Additionally at block 308, methodology 300 may include determining whether to manage the UL rate of the plurality of served UEs based at least in part on the PAI metric. For example, the PAI metric can be compared to a threshold, and where the PAI metric is over the threshold, UL rate has to be managed to control UL interference. As described above, the PAI metric can relate to a number of SNRs under a target SNR, a number of power-up commands sent to UEs, etc., and where this number is over the threshold, this can indicate that UEs are increasing transmit powers to compete with each other—potentially leading to a race condition.

Further at block 310, methodology 300 may include managing the UL data rate of the one or more user equipments by sending a message to a sub-set of the plurality of user equipments served to adjust the UL rate in response to the determining For example, managing the UL rate can include, for example, broadcasting a global indicator to the plurality of served UEs to decrease the UL rate, indicating to at least one of the plurality of served UEs to decrease the UL rate, allocating resources to the plurality of served UEs that result in a decreased UL rate, or commanding the plurality of served UEs to decrease a UL transmit power, etc.

FIG. 4 illustrates an example methodology 400 for determining whether to manage the UL rate of the one or more UEs based on a number of power-up commands to control uplink interference in heterogeneous networks. In one example, methodology 400 can be performed by base station 202, and/or, base station 102b, and/or signal comparing component 208, and/or, UL rate determining component, and/or UL rate managing component, etc., or related components, processors, and/or the like.

In an aspect, at block 402, methodology 400 may include generating a SNR PAI metric (i.e., PAI metric based on comparing SNR values to a target SNR value). For example, as SNR values fall below the target SNR value, base station 202, base station 102b, may send power up commands to the UE to increase the transit power of the UE to improve the SNR value of the UE. The power-up commands to the UE can be traced and counted to generate, for example, SNR PAI metric. In an aspect, an average number of power-up commands for a number of served UEs over a period of time can be used.

Furthermore, at block 404, methodology 400 may include determining whether to manage the UL rate of the one or more served UEs based on SNR PAI metric. For example, the SNR PAI metric may be compared with a threshold (for example, T) to determine whether to increase or decrease the UL rate.

Additionally, at block 406, methodology 400 may include managing the UL rate of the one or more UEs by sending a message to a subset of the plurality of UEs to adjust the UL rate. For example, when the number of power-up commands issued over a period of time is above a threshold, base station 202, may send a message to the UE to decrease the UL rate. In an aspect, this message can be sent to a particular UE or to a sub-set of the UEs or all the UEs served by the base station 202. In another example, the number of power-commands over a period of time is below the threshold, UL rate for the served UEs can be increased. Based on managing the UL rate of the UEs, the uplink interference in heterogeneous networks can be controlled.

It will be appreciated that, in accordance with one or more aspects described herein, inferences can be made regarding comparing SNRs to determine whether to adjust UL rates, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

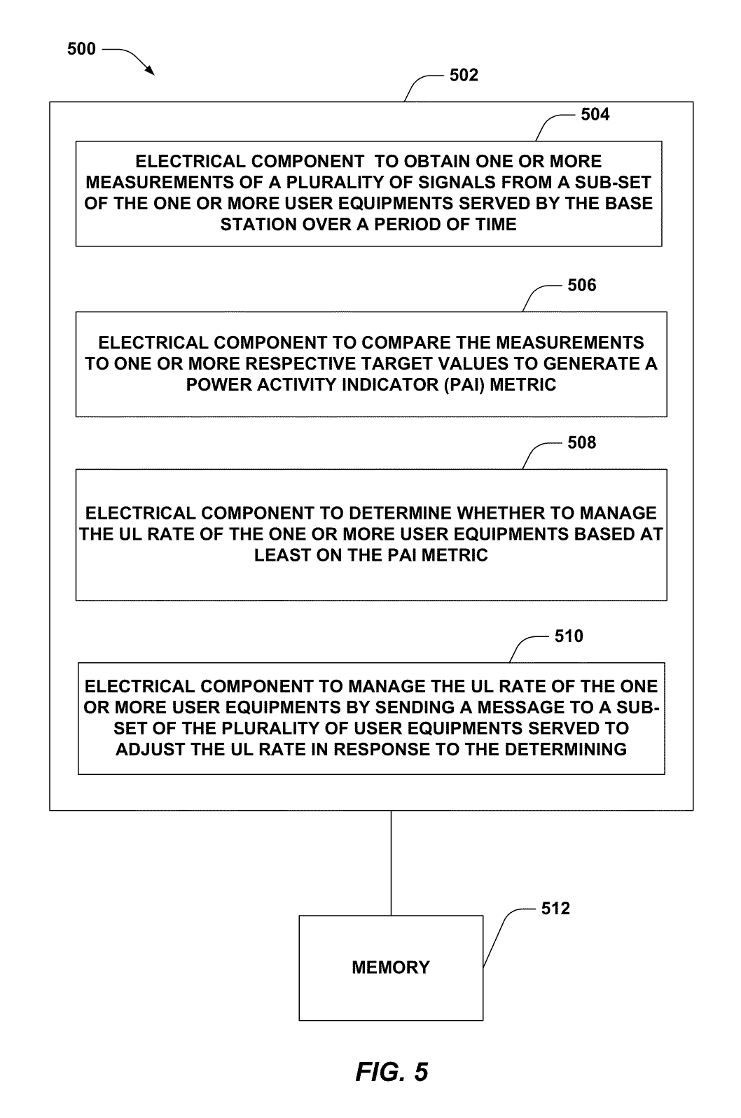

FIG. 5 illustrates a system 500 for managing UL rate for one or more UEs. For example, system 500 can reside at least partially within base station 202 or base station 202 or 102b. It is to be appreciated that system 500 is represented as including functional blocks, which can be functional blocks that represent functions implemented by a processor, software, or combination thereof (e.g., firmware). System 500 includes a logical grouping 502 of electrical components that can act in conjunction. For instance, logical grouping 502 can include an electrical component 504 for obtaining one or more measurements of a plurality of signals from a sub-set of the one or more UEs served by the base station over a period of time. In an aspect, electrical component 506 can include comparing the measurements to one or more respective target values to generate a power activity indicator (PAI) metric. Furthermore, logical grouping 502 can include an electrical component 508 for determining whether to manage the UL rate of the one or more UEs based at least on the PAI metric. In an additional aspect, logical grouping 502 can optionally include an electrical component 510 for managing the UL rate of the one or more UEs by sending a message to a sub-set of the plurality of UEs to adjust the UL rate in response to the determining

Additionally, system 500 can include a memory 512 that retains instructions for executing functions associated with the electrical components 504, 506, 508, and 510. While shown as being external to memory 512, it is to be understood that one or more of the electrical components 504, 506, 508, and 510 can exist within memory 512. In one example, electrical components 504, 506, 508, and 510 can include at least one processor, or each electrical component 504, 506, 508, and 510 can be a corresponding module of at least one processor. Moreover, in an additional or alternative example, electrical components 504, 506, 508, and 510 can be a computer program product comprising a computer readable medium, where each electrical component 504, 506, 508, and 510 can be corresponding code.

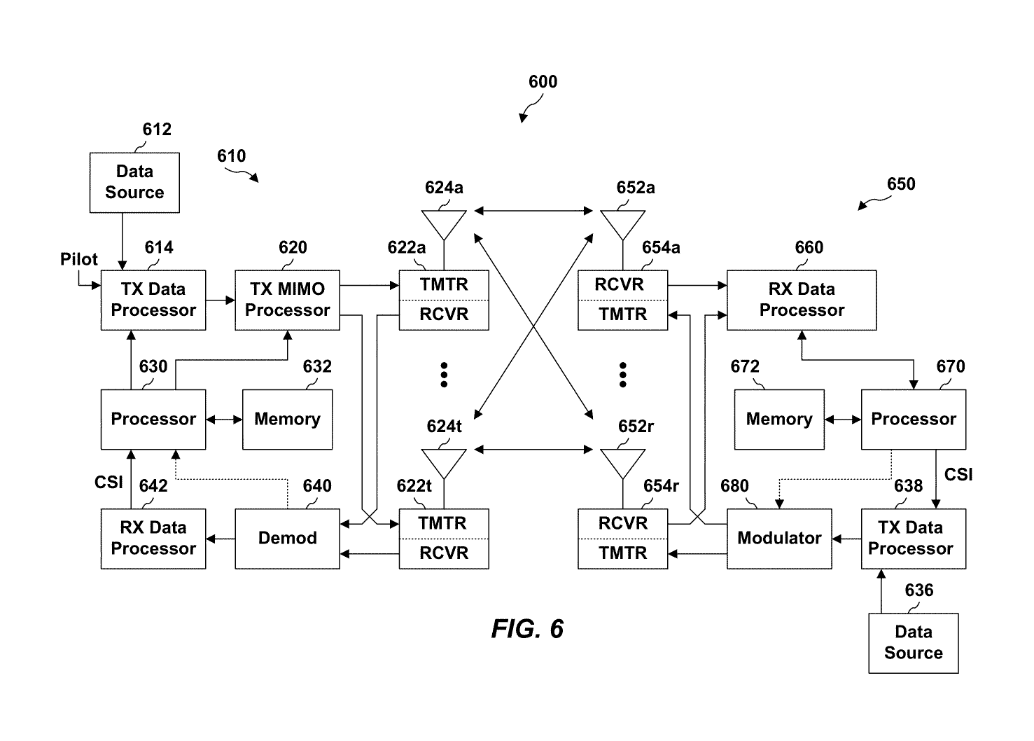

FIG. 6 shows an example wireless communication system 600. The wireless communication system 600 depicts a base station 610 and one mobile device 650 for sake of brevity. However, it is to be appreciated that system 600 can include more than one base station and/or more than one mobile device, wherein additional base stations and/or mobile devices can be substantially similar or different from example base station 610 and mobile device 650 described below. In an aspect, base station 610 can be base station 102a-d and/or 202, and mobile device can be UE 204. Moreover, base station 610 can be a low power base station, in one example, such as one or more femtocells previously described. In addition, it is to be appreciated that base station 610 and/or mobile device 650 can employ the example systems (FIGS. 1-2, 5 and 9) and/or methods (FIGS. 3-4) described herein to facilitate wireless communication there between. For example, components or functions of the systems and/or methods described herein can be part of a memory 632 and/or 662 or processors 630 and/or 660 described below, and/or can be executed by processors 630 and/or 660 to perform the disclosed functions.

At base station 610, traffic data for a number of data streams is provided from a data source 612 to a transmit (TX) data processor 614. According to an example, each data stream can be transmitted over a respective antenna. TX data processor 614 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 650 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The rate, coding, and modulation for each data stream can be determined by instructions performed or provided by processor 630.

The modulation symbols for the data streams can be provided to a TX MIMO processor 620, which can further process the modulation symbols (e.g., for OFDM). TX MIMO processor 620 then provides N_{T} modulation symbol streams to N_{T} transmitters (TMTR) 622a through 622t. In various embodiments, TX MIMO processor 620 applies beamforming weights to the symbols of the data streams and to the antenna from which the symbol is being transmitted.

Each transmitter 622 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 622a through 622t are transmitted from N_{T} antennas 624a through 624t, respectively.

At mobile device 650, the transmitted modulated signals are received by N_{R} antennas 652a through 652r and the received signal from each antenna 652 is provided to a respective receiver (RCVR) 654a through 654r. Each receiver 654 conditions (e.g., filters, amplifies, and downconverts) a respective signal, digitizes the conditioned signal to provide samples, and further processes the samples to provide a corresponding “received” symbol stream.

An RX data processor 660 can receive and process the N_{R} received symbol streams from N_{R} receivers 654 based on a particular receiver processing technique to provide N_{T} “detected” symbol streams. RX data processor 660 can demodulate, deinterleave, and decode each detected symbol stream to recover the traffic data for the data stream. The processing by RX data processor 660 is complementary to that performed by TX MIMO processor 620 and TX data processor 614 at base station 610.

The reverse link message can comprise various types of information regarding the communication link and/or the received data stream. The reverse link message can be processed by a TX data processor 638, which also receives traffic data for a number of data streams from a data source 636, modulated by a modulator 680, conditioned by transmitters 654a through 654r, and transmitted back to base station 610.

At base station 610, the modulated signals from mobile device 650 are received by antennas 624, conditioned by receivers 622, demodulated by a demodulator 640, and processed by a RX data processor 642 to extract the reverse link message transmitted by mobile device 650. Further, processor 630 can process the extracted message to determine which precoding matrix to use for determining the beamforming weights.

Processors 630 and 660 can direct (e.g., control, coordinate, manage, etc.) operation at base station 610 and mobile device 650, respectively. Respective processors 630 and 660 can be associated with memory 632 and 662 that store program codes and data. For example, processor 630 and/or 660 can execute, and/or memory 632 and/or 662 can store instructions related to functions and/or components described herein, such as measuring signals or aspects thereof, determining whether to adjust UL rates, and/or the like, as described.

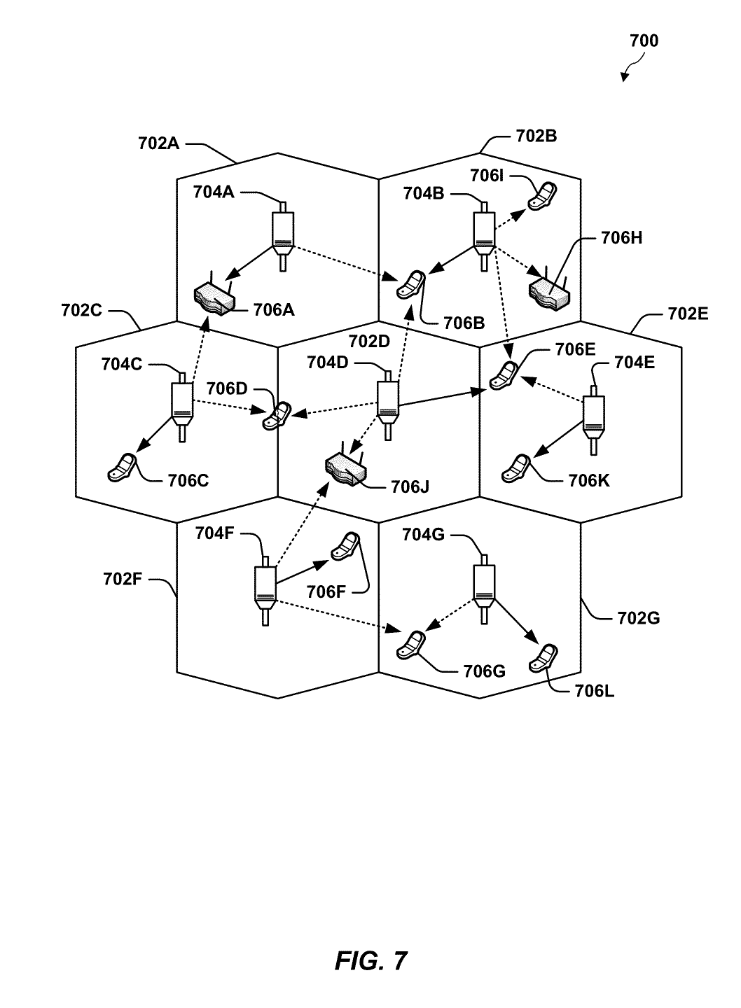

FIG. 7 illustrates a wireless communication system 700, configured to support a number of users, in which the teachings herein may be implemented. The system 700 provides communication for multiple cells 702, for example, 702A-702G, with each cell being serviced by a corresponding access node 704 (for example, access nodes 704A-704G). In an aspect, cell 702 can be base station 102a-d or 202. As shown in FIG. 7, access terminals 706 (e.g., access terminals 706A-706L) can be dispersed at various locations throughout the system over time. Each access terminal 706 can communicate with one or more access nodes 704 on a forward link (FL) and/or a reverse link (RL) at a given moment, depending upon whether the access terminal 706 is active and whether it is in soft handoff, for example. The wireless communication system 700 can provide service over a large geographic region.

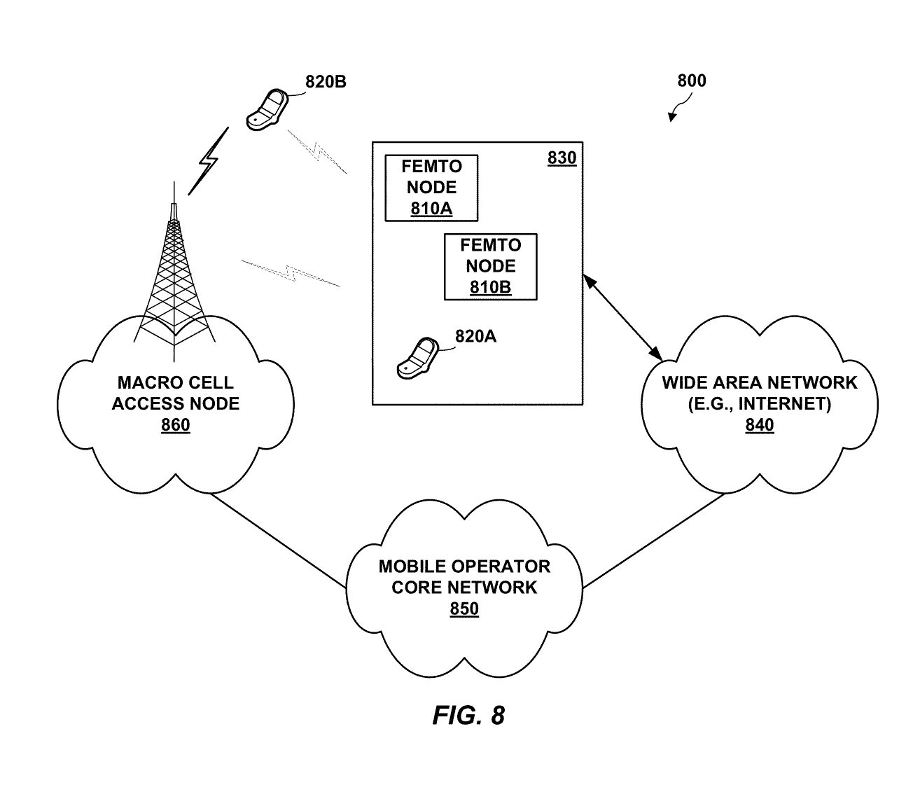

FIG. 8 illustrates an exemplary communication system 800 where one or more base stations, for example, 102a-d, 202 etc. can be deployed within a network environment. In an example aspect, system 800 can include multiple lower power base stations, for example, femto nodes, 810A and 810B. Each node 810 can be coupled to a wide area network 840 (e.g., the Internet) and a mobile operator core network 850 via a digital subscriber line (DSL) router, a cable modem, a wireless link, or other connectivity means (not shown). As will be discussed below, each femto node 810 can be configured to serve associated access terminals 820 (e.g., access terminal 820A) and, optionally, alien access terminals 820 (e.g., access terminal 820B). In other words, access to femto nodes 810 can be restricted such that a given access terminal 820 can be served by a set of designated (e.g., home) femto node(s) 810 but may not be served by any non-designated femto nodes 810 (e.g., a neighbor's femto node).

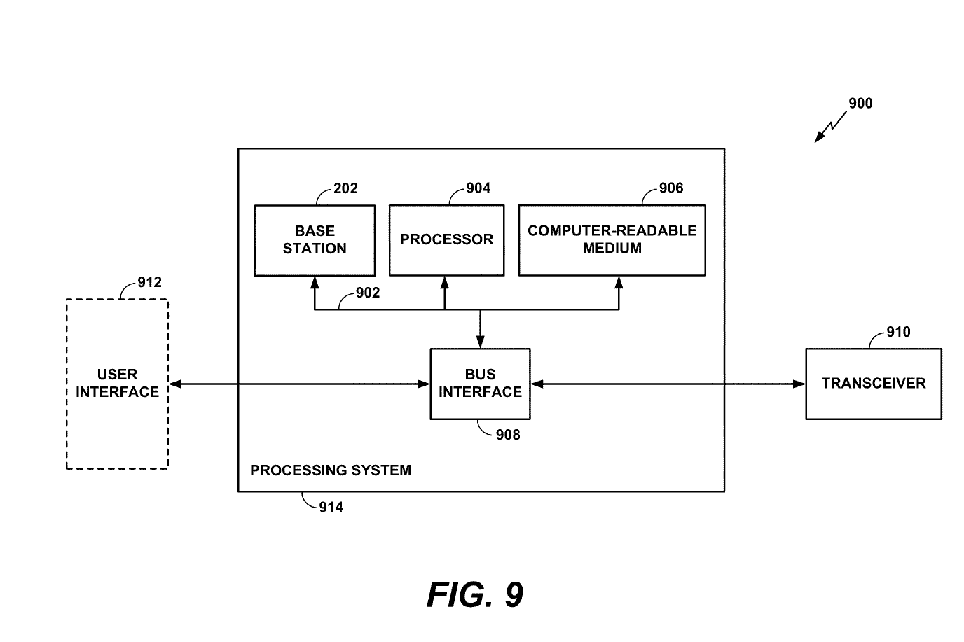

FIG. 9 is a block diagram illustrating an example of a hardware implementation for an apparatus 900 employing a processing system 914 for carrying out aspects of the present disclosure, such as methods for improved cell reselection. In this example, the processing system 914 may be implemented with a bus architecture, represented generally by a bus 902. The bus 902 may include any number of interconnecting buses and bridges depending on the specific application of the processing system 914 and the overall design constraints. The bus 902 links together various circuits including one or more processors, represented generally by the processor 904, computer-readable media, represented generally by the computer-readable medium 906, and one or more components described herein, such as, but not limited to, base stations 202, signal measuring component 206, signal comparing component 208, UL rate determining component 210, and/or UL rate managing component 212 (FIGS. 1 and 2). The bus 902 may also link various other circuits such as timing sources, peripherals, voltage regulators, and power management circuits, which are well known in the art, and therefore, will not be described any further. A bus interface 908 provides an interface between the bus 902 and a transceiver 910. The transceiver 910 provides a means for communicating with various other apparatus over a transmission medium. Depending upon the nature of the apparatus, a user interface 912 (e.g., keypad, display, speaker, microphone, joystick) may also be provided.

The processor 904 is responsible for managing the bus 902 and general processing, including the execution of software stored on the computer-readable medium 909. The software, when executed by the processor 904, causes the processing system 914 to perform the various functions described infra for any particular apparatus. The computer-readable medium 909 may also be used for storing data that is manipulated by the processor 904 when executing software.

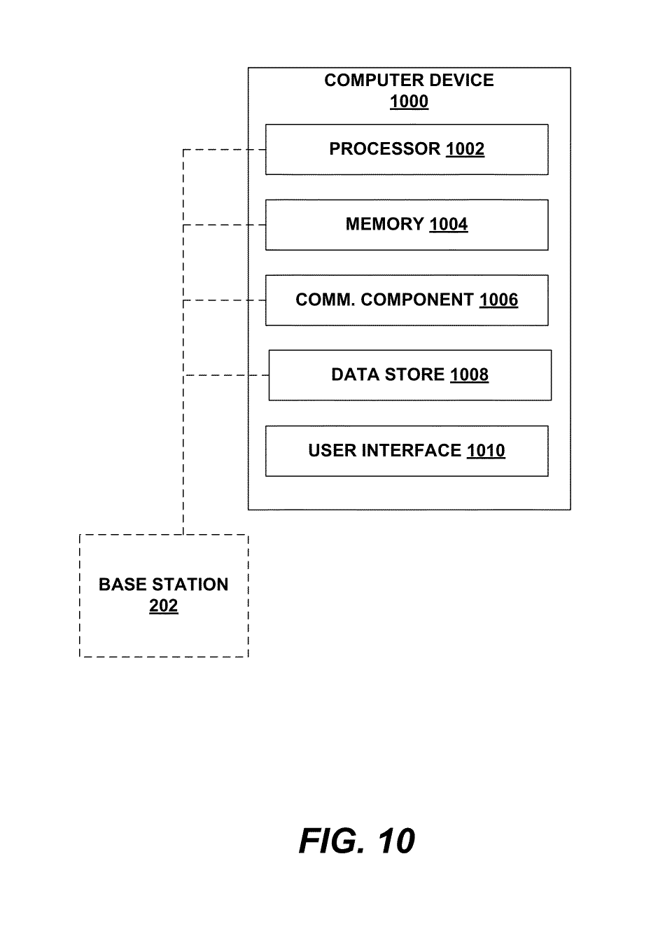

Referring to FIG. 10, in one aspect, any of base station 102a-d and/or 202 (FIGS. 1-2) may be represented by a specially programmed or configured computer device 1000. In one aspect of UE implementation (for example, base station 202 of FIG. 2), computer device 1000 may include signal measuring component 206, signal comparing component 208, UL rate determining component 210, and/or UL rate managing component 212 (FIGS. 1 and 2), such as in specially programmed computer readable instructions or code, firmware, hardware, or some combination thereof. Computer device 1000 includes a processor 1002 for carrying out processing functions associated with one or more of components and functions described herein. Processor 1002 can include a single or multiple set of processors or multi-core processors. Moreover, processor 1002 can be implemented as an integrated processing system and/or a distributed processing system.

Computer device 1000 further includes a memory 1004, such as for storing data used herein and/or local versions of applications being executed by processor 1002. Memory 1004 can include any type of memory usable by a computer, such as random access memory (RAM), read only memory (ROM), tapes, magnetic discs, optical discs, volatile memory, non-volatile memory, and any combination thereof.

Further, computer device 1000 includes a communications component 1006 that provides for establishing and maintaining communications with one or more parties utilizing hardware, software, and services as described herein. Communications component 1006 may carry communications between components on computer device 1000, as well as between computer device 1000 and external devices, such as devices located across a communications network and/or devices serially or locally connected to computer device 1000. For example, communications component 1006 may include one or more buses, and may further include transmit chain components and receive chain components associated with a transmitter and receiver, respectively, or a transceiver, operable for interfacing with external devices. In an additional aspect, communications component 1006 may be configured to receive one or more pages from one or more subscriber networks. In a further aspect, such a page may correspond to the second subscription and may be received via the first technology type communication services.

Additionally, computer device 1000 may further include a data store 1008, which can be any suitable combination of hardware and/or software, that provides for mass storage of information, databases, and programs employed in connection with aspects described herein. For example, data store 1008 may be a data repository for applications not currently being executed by processor 1002 and/or any threshold values or finger position values.

Computer device 1000 may additionally include a user interface component 1010 operable to receive inputs from a user of computer device 1000, and further operable to generate outputs for presentation to the user. User interface component 1010 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof Further, user interface component 1010 may include one or more output devices, including but not limited to a display, a speaker, a haptic feedback mechanism, a printer, any other mechanism capable of presenting an output to a user, or any combination thereof.

For convenience, the disclosure herein describes functionality in the context of a femtocell. It should be appreciated, however, that a macro cell or a pico cell or any type of base station equipment can provide the same or similar functionality as a femtocell, but for a larger/smaller coverage area.

A wireless multiple-access communication system can simultaneously support communication for multiple wireless access terminals. As mentioned above, each terminal can communicate with one or more base stations via transmissions on the forward and reverse links. The forward link (or downlink) refers to the communication link from the base stations to the terminals, and the reverse link (or UL) refers to the communication link from the terminals to the base stations. This communication link can be established via a single-in-single-out system, a MIMO system, or some other type of system.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal In the alternative, the processor and the storage medium may reside as discrete components in a user terminal.

In one or more aspects, the functions, methods, or algorithms described may be implemented in hardware, software, firmware, or any combination thereof If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for controlling an uplink (UL) rate of one or more user equipments (UEs) served by a base station, comprising:
obtaining one or more measurements of a plurality of signals from a sub-set of the one or more UEs served by the base station over a period of time;
comparing the measurements to one or more respective target values to generate a power activity indicator (PAI) metric; and
determining whether to manage the UL rate of the one or more UEs based at least on the PAI metric.

2. The method of claim 1, wherein the determining is based on identifying whether the PAI metric is above a threshold.

3. The method of claim 1, further comprising:
managing the UL rate of the one or more UEs by sending a message to a sub-set of the plurality of UEs to adjust the UL rate in response to the determining.

4. The method of claim 3, wherein the managing can be performed at a UE level or a base station level.

5. The method of claim 3, wherein the managing further comprises: scheduling resources to the one or more plurality of UEs using a scheduler without coordinating with other base stations.

6. The method of claim 1, wherein the one or more measurements are selected from a list comprising a signal-to-noise ratio (SNR), a signal-to-interference plus noise ratio (SINR), and a number of power change commands corresponding to the signals received by the base station over a period of time.

7. The method of claim 1, wherein the target values are selected from a list comprising a SNR threshold, a SINR threshold, and a number of power change commands over a period of time.

8. The method of claim 1, wherein the PAI metric is calculated based at least on a sum of the differences between the measurements and the respective target values for the one or more UEs.

9. The method of claim 1, further comprising:
assigning weights to the measurements, wherein the weights are assigned based at least on the UL transmit power of the UE.

10. An apparatus for controlling an uplink (UL) rate of one or more user equipments (UEs) served by a base station, comprising:
means for obtaining one or more measurements of a plurality of signals from a sub-set of the one or more UEs served by the base station over a period of time;
means for comparing the measurements to one or more respective target values to generate a power activity indicator (PAI) metric; and
means for determining whether to manage the UL rate of the one or more UEs based at least on the PAI metric.

11. The apparatus of claim 10, wherein the means for determining is further configured to identify whether the PAI metric is above a threshold.

12. The apparatus of claim 10, further comprising:
means for managing the UL rate of the one or more UEs by sending a message to a sub-set of the plurality of UEs to adjust the UL rate in response to the determining.

13. The apparatus of claim 12, wherein the means for managing is further configured to manage at a UE level or a base station level.

14. The apparatus of claim 12, wherein the means for managing is further configured to schedule resources to the one or more plurality of UEs using a scheduler without coordinating with other base stations.

15. The apparatus of claim 10, wherein the one or more measurements are selected from a list comprising a signal-to-noise ratio (SNR), a signal-to-interference plus noise ratio (SINR), and a number of power change commands corresponding to the signals received by the base station over a period of time.

16. The apparatus of claim 10, wherein the means for comparing is further configured to select the respective target values from a list comprising a SNR threshold, a SINR threshold, and a number of power change commands over a period of time.

17. The apparatus of claim 10, wherein the means for comparing is further configured to calculate the PAI metric based at least on a sum of the differences between the measurements and the respective target values for the one or more UEs.

18. The apparatus of claim 10, further comprising:
means for assigning weights to the measurements, wherein the weights are assigned based at least on the UL transmit power of the UE.

19. A computer program product for controlling an uplink (UL) rate of one or more user equipments (UEs) served by a base station, comprising: a computer-readable medium comprising code for:
obtaining one or more measurements of a plurality of signals from a sub-set of the one or more UEs served by the base station over a period of time;
comparing the measurements to one or more respective target values to generate a power activity indicator (PAI) metric; and
determining whether to manage the UL rate of the one or more UEs based at least on the PAI metric.

20. The computer program product of claim 19, wherein the code for determining further comprises code for identifying whether the PAI metric is above a threshold.

21. The computer program product of claim 19, further comprising:
code for managing the UL rate of the one or more UEs by sending a message to a sub-set of the plurality of UEs to adjust the UL rate in response to the determining.

22. The computer program product of claim 21, wherein the code for managing further comprises code for performing at a UE level or a base station level.

23. The computer program product of claim 21, wherein the code for managing further comprises code for scheduling resources to the one or more plurality of UEs using a scheduler without coordinating with other base stations.

24. The computer program product of claim 19, wherein the code for obtaining further comprises code for selecting the one or more measurements from a list comprising a signal-to-noise ratio (SNR), a signal-to-interference plus noise ratio (SINR), and a number of power change commands corresponding to the signals received by the base station over a period of time.

25. The computer program product of claim 19, wherein the code for comparing further comprises code for selecting the target values from a list comprising a SNR threshold, a SINR threshold, and a number of power change commands over a period of time.

26. The computer program product of claim 19, where in the code for comparing further comprises code for generating the PAI metric based at least on a sum of the differences between the measurements and the respective target values for the one or more UEs.

27. The computer program product of claim 19, further comprising code for assigning weights to the measurements, wherein the weights are assigned based at least on the UL transmit power of the UE.

28. An apparatus for controlling an uplink (UL) rate of one or more user equipments (UEs) served by a base station, comprising:
a signal measuring component to obtain one or more measurements of a plurality of signals from a sub-set of the one or more UEs served by the base station over a period of time;
a signal comparing component to compare the measurements to one or more respective target values to generate a power activity indicator (PAI) metric; and
a UL rate determining component to determine whether to manage the UL rate of the one or more UEs based at least on the PAI metric.

29. The apparatus of claim 28, wherein the UL rate determining component is further configured to determine whether to manage the UL rate based on whether the PAI metric is above a threshold.

30. The apparatus of claim 28, further comprising:
a UL rate managing component to manage the UL rate of the one or more UEs by sending a message to a sub-set of the plurality of UEs to adjust the UL rate based on the PAI metric.

31. The apparatus of claim 30, wherein the UL rate managing component is further configured to manage at a UE level or a base station level.

32. The apparatus of claim 30, wherein UL rate managing component is further configured to schedule resources to the one or more plurality of UEs using a scheduler without coordinating with other base stations.

33. The apparatus of claim 28, wherein the signal measuring component is further configured to select the one or more measurements from a list comprising a signal-to-noise ratio (SNR), a signal-to-interference plus noise ratio (SINR), and a number of power change commands corresponding to the signals received by the base station over a period of time.

34. The apparatus of claim 28, wherein the signal comparing component is further configured to select the target values from a list comprising a SNR threshold, a SINR threshold, and a number of power change commands over a period of time.

35. The apparatus of claim 28, wherein the signal comparing component is further configured to calculate the PAI metric based at least on a sum of the differences between the measurements and the respective target values for the one or more UEs.

36. The apparatus of claim 28, further comprising means for assigning weights to the measurements, wherein the weights are assigned based at least on the UL transmit power of the UE.
